(19) United States
(12) Patent Application Publication
(10) Pub. No.: US 2008/0225669 A1
(43) Pub. Date: Sep. 18, 2008

(54) Method of Checking the Cleanness Status of a Refractive Element and Optical Scanning Apparatus of Th Enear Field Type

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/066,538

(22) PCT Filed: Sep. 8, 2006
(86) PCT No.: PCT/IB06/53170

§ 371 Date: Mar. 12, 2008

(30) Foreign Application Priority Data
Sep. 12, 2005 (EP) 05108330.1

(51) Int. Cl. G11B 7/00

(52) U.S. Cl. 369/100

(57) ABSTRACT

A method of checking the cleanness status of an optical exit face of a refractive element of an optical scanning apparatus of the near field type, the method comprising step of generating a near field control signal proportional to ratio between the intensity of an optical radiation beam that is internally reflected from the optical exit face of the refractive element and the intensity of a corresponding incident optical radiation beam; measuring the near field control signal when the optical exit face of the refractive element is further away from an optical disc than a near field distance; comparing the measured near field control signal with a predetermined threshold value; deciding the refractive element is clean if the measured near field control signal is above the predetermined threshold value.

### FIELD OF THE INVENTION

The present invention relates generally to a method of checking the cleanness status of an optical exit face of a refractive element of an optical scanning apparatus of the near field type. The present invention also relates to an optical scanning apparatus of the near field type.

### BACKGROUND OF THE INVENTION

An optical scanning apparatus scans an optical disc by means of a optical radiation beam focused in a small spot onto the optical disc. Scanning an optical disc is to be understood as reading from and/or writing onto an information layer of the optical disc. The maximum data density that can be read and/or recorded on an optical disc inversely scales with the size of the radiation spot that is focused onto the optical disc. The smaller the spot focused onto the disc, the larger the data density that can be recorded on the optical disc. The afore-mentioned spot size in turn is determined by the ratio of the wavelength λ of the scanning optical radiation beam generated by the optical radiation source, for example a laser, and the numerical aperture (NA) of the focusing lens, which, can also be referred to as objective lens.

It is known in the art that achieving numerical apertures (NA) exceeding unity requires a so-called ‘near field’ configuration, wherein a refractive element of the optical scanning apparatus is placed between the objective lens and the optical disc such that the refractive element is spaced from an exit surface of the optical disc at a readout distance less than a near field distance, such readout distance being much less than one half of a wavelength, in practice the readout distance being smaller than a few tens of nanometers.

Known designs of optical scanning apparatuses that allow fulfilling the aforementioned distance requirements when reading or writing from/onto the optical disc are systems making use of sliders, analogous to magnetic recording systems and active feedback systems making use of actuators. For both slider and actuator designs a technical challenge is to maintain an optical exit face of the refractive element clean, i.e. contaminant and dust free. Such contaminants or dust adhering to the surface in the path of the radiation can adversely affect the optical signal or the ability of the optical scanning apparatus to control the distance to the surface of the optical disc accurately, leading to degradation in performance or, in extreme cases, to malfunction of the optical scanning apparatus.

With respect to dirt and contaminants, an important issue is being able to determine whether the optical exit face of the refractive element is clean. U.S. Pat. No. 6,307,832 describes a method of operating a disc drive of the near field type comprising bringing an optical disc at a readout distance from the optical head, monitoring the envelope of the tracking signal while reading out data from the optical disc, deciding that the optical head needs cleaning if the distortion of the envelope of the tracking signal exceeds a predetermined tolerance level. However, the method as described in U.S. Pat. No. 6,307,832 can only be performed during a read/write operation. Consequently, it may be used only if it is already possible to bring the optical disc to a readout distance and align it with respect to the optical head. If the optical exit face of the refractive element of the optical head is very dirty/heavily contaminated, aligning the optical disc is not possible and, in extreme cases, attempting to do so may lead to malfunction of the optical scanning apparatus. Consequently, the said method has the disadvantage that it is not very robust, as it requires the ability to bring to a readout distance and align the optical disc with respect to the optical head.

### SUMMARY OF THE INVENTION

It is an object of the invention to provide a more robust method of checking the cleanness status of a refractive element of an optical scanning apparatus of the near field type, which does not require the ability to align the optical disc. This object is achieved by a method according to the invention characterized as recited in claim 1. Inside a near field refractive element, all rays of an incident optical radiation beam having an angle of incidence larger than the numerical aperture (NA) are totally internally reflected, if no suitable media is very close or in contact with the optical exit face of the refractive element. Consequently, if no media is close to the refractive element, i.e. the optical disc is further away from the optical exit face of the refractive element than a near field distance, a near field control signal has a maximum value; the near field control signal being chosen such that proportional to the ratio between the intensity of an optical radiation beam that is internally reflected from the optical exit face of the refractive element and the intensity of a corresponding incident optical radiation beam. However, if dust or contaminants are present on the optical exit face, then the process of total internal reflection will be partially frustrated and the absolute value of the near field control signal, which scales proportional with the intensity of the reflected optical radiation beam, will be reduced. Comparing whether the measured value of the near field control signal when the optical disc is further away from the optical exit face of the refractive element than a near field distance is above a predetermined threshold value allows to decide whether the refractive element is clean or not. As during the measurement the optical disc is maintained further away from the optical exit face of refractive element, the method according to the invention does not require the ability to bring the optical exit face of the refractive element within a readout distance or the ability to align the optical disc.

In a preferred embodiment, the near field control signal is a Gap Error Signal (GES), the Gap Error Signal (GES) being proportional to the intensity of a reflected optical radiation beam having a polarization state perpendicular to the polarization state of the incident scanning optical radiation beam. Such a choice carries the advantage that Gap Error Signal (GES) is already available in some optical scanning system of the near field type, therefore requiring minimal hardware modification.

In an advantageous embodiment, the predetermined threshold value is chosen such that it falls in a range from 90% to 99% of the value of the near field control signal measured when the refractive element is clean and the optical disc is outside a near field distance from the refractive element.

It is advantageous that the refractive element is brought out of focus before measuring the near field control signal. If the incident optical radiation beam is focused in a spot on or very close to the optical exit face of the refractive element, the area of the optical exit face of the refractive element that is probed for the cleanness status is rather small. In other words, contamination/dirt outside the focused spot area does not influence the near field control signal. If the optical radiation beam is defocused, a larger area in the order of 10-30 μm in diameter is probed. Therefore, contamination can be detected in a much larger area, almost covering the entire optical exist surface of the refractive element. Obviously, the predetermined threshold value for the near field control signal should be determined for the same focusing condition as during the near field control signal measurement step. Preferably the defocusing of the incident optical radiation beam is obtained by moving a collimator of an optical pick-up unit.

An improved embodiment is obtained by the measures of claim 6. By monitoring an optical control signal, it is possible to detect a deterioration of the intensity or the quality of the optical radiation beam that is reflected. For example, in case some contamination or dirt is present, the transmission of the refracted element and/or the spot quality will be affected, leading to a reduced or distorted optical control signal. It carries the advantage that it is simple to implement as such optical control signals are already present in an optical scanning apparatus, detection is very easy and can be performed during a read/write operation. Preferably, from the available optical control signals, an optical control signal used for tracking, e.g. the push-pull signal, is chosen. Such a choice has the advantage that it may also be used during recording or scanning empty tracks, as it does not require that reliable data can be read from the optical disc, which may not be the case during recording or while scanning empty tracks.

In an advantageous embodiment, the method further comprises steps of bringing the optical disc in contact with the optical exit face of the refractive element, measuring the near field control signal; comparing the measured near field control signal with a second threshold value and deciding that the refractive element is clean if the measured near field control signal is below a second threshold value. In the clean situation, the value of the near field control signal when the optical disc is in contact with the optical exit face of the refractive element is low and larger values indicate the presence of contamination/dirt on the optical exit face of the refractive element. The embodiment has the advantage that the entire surface of the optical exit face of the refractive element is probed. Preferably, the second threshold value is chosen in a range from 0% to 20% of the value of the measured near field control signal when then refractive element is clean and the optical disc is outside a near field distance from the refractive element.

The invention also relates to a near field optical scanning apparatus for scanning an optical disc.

These and other aspects of the invention are apparent from and will be explained with reference to the embodiments described hereinafter. In the following, it is understood that the term refractive element encompasses many optical elements, which may include a Solid Immersion Lens (SIL) for near field systems, and that the use of the term Solid Immersion Lens (SIL) in the description for purposes of explanation does not limit the application of the invention to only a SIL lens.

### BRIEF DESCRIPTION OF THE DRAWINGS

The features and advantages of the invention will be appreciated upon reference to the following drawings, in which:

FIG. 1 illustrates schematically an optical scanning apparatus wherein the invention may be practiced;

FIG. 2 illustrates schematically an optical pick-up unit of the optical scanning apparatus;

FIG. 3 illustrates schematically a solid immersion lens (SIL);

FIG. 4 illustrates the measured Gap Error Signal (GES) as function of the distance between the optical exit face of the refractive element, e.g. solid immersion lens (SIL), and the surface of the optical disc;

FIG. 5 illustrates a first embodiment of a method of checking the cleanness status of an optical exit face of a refractive element according to the invention;

FIG. 6 illustrates a second embodiment of a method of checking the cleanness status of an optical exit face of a refractive element according to the invention;

FIG. 7 illustrates a third embodiment of a method of checking the cleanness status of an optical exit face of a refractive element according to the invention;

### DETAILED DESCRIPTION OF THE PREFERRED EMBODIMENTS

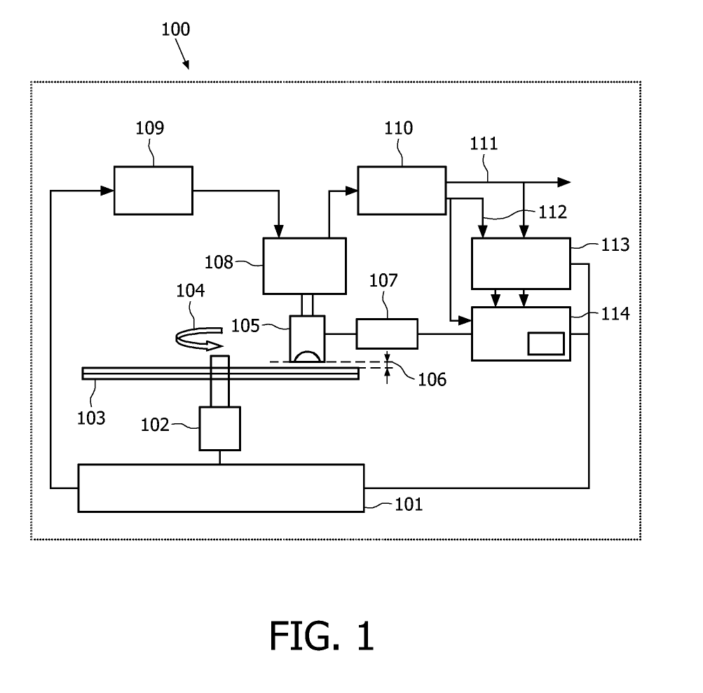

FIG. 1 illustrates schematically an optical scanning apparatus of the near field type wherein the invention may be practiced. A detailed description of such apparatus can be found in Proceedings of SPIE (Optical Data Storage 2004), ed. B. V. K. Vijaya Kumar, Vol. 5380, pp 209-223.

The apparatus 100 forms part of a near field optical system. The device comprises a control unit 101 which is connected to a motor control 102 upon which rests a chuck 116 where an optical disc 103 can be placed. The optical disc 103 can be caused to rotate 104 during reading and writing operations of the optical system. Above the optical disc 103, the refractive element, for example a solid immersion lens (SIL), of the near field system is contained in the head assembly 105. The head assembly 105 is positioned above the optical disc 103 at a specific distance 106 by the servo unit 107. The optical radiation beam incident on the optical disc 103 originates from the Front-end unit 108, which contains laser, optics, detectors etc, and which receives operational instructions from the control unit 101 via a unit 109 where inputs are formatted and modulated.

To allow control of the specific distance 106 between the optical disc 103 and the head assembly 105, also known as the air gap, by means of a mechanical actuator at such small distances, a suitable control signal is required as input for the gap servo system. It is known that a suitable control signal can be obtained from a reflected optical radiation beam with a polarization state which is, for example, perpendicular to that of the scanning optical radiation beam that is focused on the optical disc. A significant fraction of the optical radiation beam becomes elliptically polarized after reflection at the SIL-air-optical disc interfaces. This effect can create the well-known “Maltese cross” when the reflected optical radiation beam is observed through a polarizer. The control signal is generated by integrating all the light of this “Maltese cross” using polarizing optics and a radiation detector, for example a single photo detector. The value of the photo detector is close to zero for the distance 106 being zero (mechanical contact), and increases with increasing the distance 106 and levels off at a maximum value when the distance 106 is approximately a tenth of the wavelength of the optical radiation beam.

The head assembly 105 comprises another detector (not shown), which is used for detection of optical radiation, that is polarized parallel to the forward optical radiation beam that is focused on the optical disc 103 and contains the information read from or written on the optical disc 103. The control signal is known as the Gap Error Signal (GES) and, together with the corresponding servo methods, has been described and demonstrated in the reference cited above and also in Jpn. J. Appl. Phys. Vol. 42 (2003) pp2719-2724, Part 1, No. 5A, May 2003 and in Technical Digest ISOM/ODS 2002, Hawaii, 7-11 Jul. 2002 ISBN 0-7803-7379-0.

Output from the Front end unit 108 is fed into the signal processing unit 110. This output contains, among other things, readout data and Gap Error Signal (GES) distance measurements. Readout data 111 is directed towards a separate subsystem. The GES signal 112 is fed into a threshold unit 113. This threshold unit comprises one or more threshold values which have been predetermined and programmed into the unit. In addition the programming contains appropriate reactions which must be implemented if any of the measured distances are outside the threshold values. Comparison between measured distances and thresholds takes place and the appropriate reaction is chosen if necessary. This information is then fed into the Air gap control unit 114 which acts to implement the chosen reaction by controlling the servo unit 107, which in turn controls the head assembly 105 comprising the SIL lens.

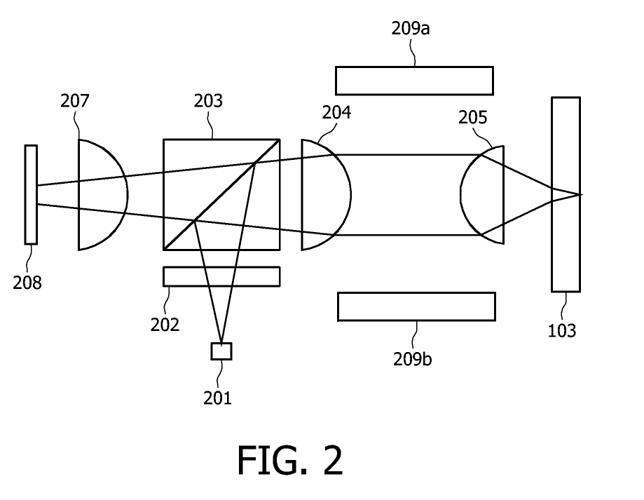

Further details of an optical pick-up unit (OPU) comprising the head assembly 105 and of the Front-end unit 108 will be discussed with reference to FIG. 2. This is meant as an illustrative example and several other embodiments are known in the art.

The optical radiation beam, for example a monochromatic laser beam, is generated by a laser diode 201 and it passes through a grating 202, which allows generating a three-beam system comprising a main beam and two satellite spots. The optical radiation beam further passes through a beamsplitter 203, a collimator lens 204. The optical pick-up unit (OPU) may further comprise a polarizing beam splitter (not shown in FIG. 2) for polarizing the incident optical radiation beam for generating the Gap Error Signal (GES). Finally, the optical radiation beam is focused into a spot onto an information layer provided onto the optical disc 106 by means of the objective lens 205 and a refractive element 206, for example a solid immersion lens (SIL). The information layer onto the optical disc 103 may be covered by a cover layer for mechanical protection against scratches. Part of the optical radiation beam that is reflected by the information layer in optical disc passes is transmitted through the beamsplitter 203 towards a servo lens 207 and a detector 208. For generating the Gap Error Signal (GES) a second polarizer and detector (not shown in FIG. 2) may be used. The mechanical actuator system 209a and 209b is responsibly for adjusting the position of the solid immersion lens (SIL) 206 and/or of the objective lens 205 with respect to the optical disc.

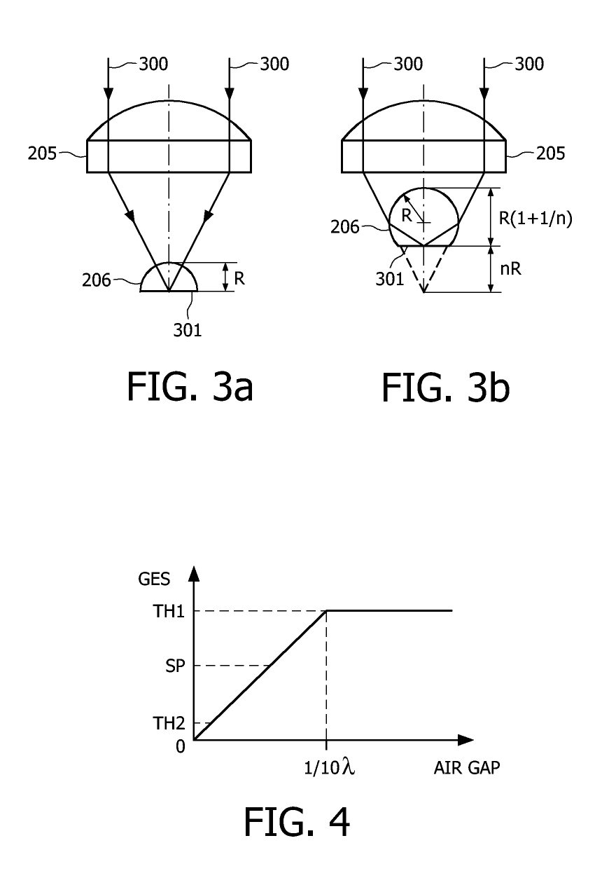

Further details of the solid immersion lens (SIL) 206 will be discussed with reference to FIG. 3. The numerical aperture (NA) of a lens can exceed unity if the light is focused in a high index medium without refraction at the air-medium interface, for example by focusing in the center of a hemispherical solid immersion lens (SIL) 206 as shown in FIG. 3a. In this case, the effective NA is NA_{eff}=n NA₀, wherein n is the refractive index of the hemispherical solid immersion lens (SIL) 206 and NA₀ is the NA in air of the objective lens 205 according to FIG. 3a).

In order to further increase the NA, it is known in the art to use a super-hemispherical solid immersion lens as shown in FIG. 3b). A super-hemispherical lens refracts the optical radiation beam towards the optical axis. Now, the effective NA is NA_{eff}=n² NA₀. The optical thickness of the super-hemispherical solid immersion lens (SIL) is R(1+1/n), where n is the refractive index of the lens material and R is the radius of the semi-spherical portion of the solid immersion lens (SIL) 206.

It is important to note that an effective NA_{eff} larger than unity is only present within an extremely short distance from the optical exit face 301 of the solid immersion lens were an evanescent wave exists. The distance is typically smaller than one tenth of the wavelength of the radiation. The afore-mentioned distance is also called the near field distance. This short near field means that during writing or reading an optical record carrier the distance between the solid immersion lens (SIL) and the optical disc must at all times be smaller than a few tens of nanometers. This is because at least a part of the scanning optical radiation beam incident on the optical exit face 301 of the solid immersion lens (SIL) is totally reflected at the lens-air-interface wherein the totally reflected part of the optical radiation beam evanesces just a very small distance into the optically thinner medium.

FIG. 4 illustrates the measured Gap Error Signal (GES) as function of the distance between the optical exit face 301 of the refractive element, e.g. solid immersion lens (SIL), and the surface of the optical disc 103. For zero air gap 106, i.e. when the entrance face 42 of the optical disc 103 is in contact with the optical exit face 301 of the solid immersion lens (SIL) 206, the Gap Error Signal (GES) is close to zero. With increasing gap width, the gap signal increases, wherein the linear dependence of the Gap Error Signal (GES) on the air gap 106 as shown in FIG. 4 is only arbitrary. At about 1/10 λ, the Gap Error Signal (GES) does not further increase with the air gap 106, because there is no longer an evanescent coupling of the scanning optical radiation beam into the optical disc 103 and reflection of the optical radiation beam from the optical exit face 301 is maximum.

There is a certain value of the Gap Error Signal (GES), the set-point SP, which corresponds to the desired air gap 106 between the optical disc 103 and the solid immersion lens 205. The Gap Error Signal (GES) and a fixed voltage equal to the set-point SP are input in a subtractor (not shown) which forms a signal at its output used to control the gap servo system which controls the air gap 106.

The description of the near field optical scanning apparatus until this point was made under the assumption that the solid immersion lens 205 is correctly adjusted in the optical pick-up unit (OPU) and clean. However, if the optical exit face 301 of the refractive element of the optical head is very dirty/heavily contaminated, bringing the optical exit face of the solid immersion lens (SIL) 206 to a near field distance with respect to the optical disc 103 and/or aligning the optical pick-up unit (OPU) with respect to a track of the optical disc 103 may not possible and, in extreme cases, attempting to do so may lead to malfunction of the optical scanning apparatus. It is the object of this invention to describe a suitable method for checking the cleanness status of the optical exit face of the refractive element

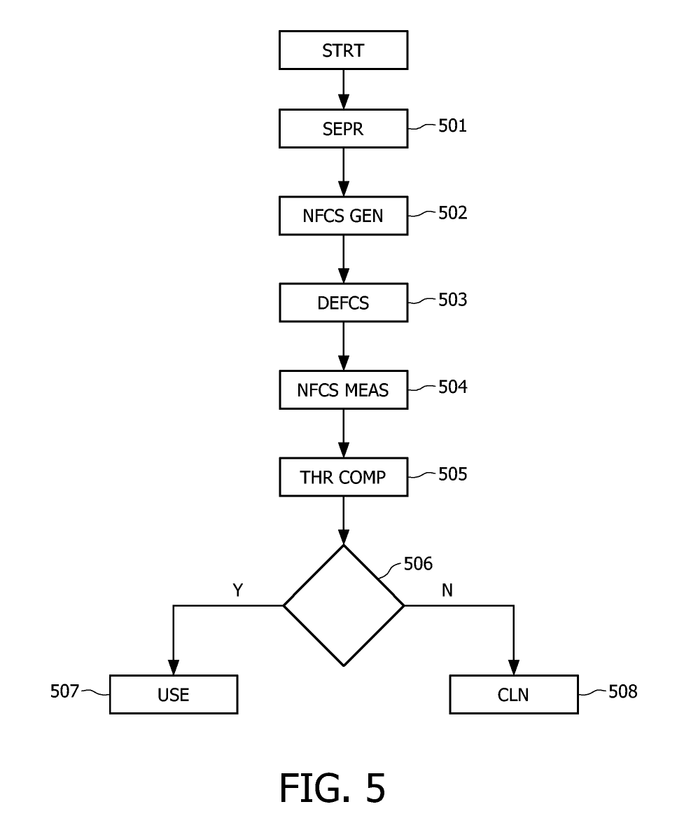

FIG. 5 illustrates a first embodiment of a method of checking the cleanness status of an optical exit face of a refractive element according to the invention; Further reference will be made to the optical scanning apparatus of the near field type as described with reference to FIG. 1 and the optical pick-up unit as described with reference to FIG. 2.

The method for checking the cleanness status is preferably performed every time the optical scanning apparatus is started, or, optionally after a new optical disc 103 has been introduced in the system. The method starts by an optional step 501 of checking the distance between the optical disc 103 and the solid immersion lens 206. If the optical disc 103 was within a readout distance, the disc is then separated (SEPR) at a distance larger than a near field distance, that is at a distance sufficiently large that no evanescent coupling is present between the scanning optical radiation beam and the optical disc. Such a distance in general is in the order of one tenth of a wavelength. If the method is performed immediately after start-up, step 501 may be skipped. The method continues with step 502, wherein a near field control signal is generated (NFCS GEN), the near field control signal being proportional to the intensity of an optical radiation beam that is totally internally reflected from the optical exit face of solid immersion lens 205. In a preferred embodiment, the Gap Error Signal 503 is chosen as the near field control signal.

Optionally, in a preferred embodiment of the method, the step 502 of generating the near field control signal is followed by a defocusing step (DEF) 503. For example, the defocusing can be obtained by moving the collimator lens 204 with respect to the solid immersion lens (SIL) 206. For a perfectly focused system and in the case the optical disc is not covered by a protective layer, that is when the optical radiation beam is focused in a small spot on or very close to the bottom of solid immersion lens (SIL) 206, the area of the exit face of the solid immersion lens (SIL) 206 that can be inspected in this way is quite small. In other words, contamination outside the spot area does not influence the near field control signal. If the incident optical radiation beam is defocused on the optical exit face of the solid immersion lens (SIL) 206, this may increase the effective spot size of the incident optical radiation beam at the optical exit face to a diameter in the order of 10-20 μm. Therefore, contamination can be detected over a much larger area, almost covering the entire optical exit face of the solid immersion lens (SIL) 206.

In step 504, the generated near field control signal is measured (NFCS MEAS) and in step 505 is compared to a predetermined threshold value (THR COMP). A near field control signal proportional to the intensity of the optical radiation beam that has suffered total internal reflection will show the same dependence of the air gap distance as the one illustrated for the Gap Error Signal (GES) in FIG. 4. At about 1/10 λ, the near field control signal does not further increase with increasing the air gap, because there is no longer an evanescent coupling of the optical radiation beam into the optical disc 103 and reflected optical radiation beam from the optical exit face 301 of the solid immersion lens (SIL) 206 is maximum. When normalized to the power of the incident optical radiation beam, this latter value is only determined by the status of optical exit face of the solid immersion lens (SIL) 206. Thus, when the value of the near field control signal in the absence of a disc (or with the disc further away than a near field distance in the order of a few 100 nm) is lower than a predetermined reference value (in the original, clean situation), this means that there is some contamination on the bottom of the SIL located close to or on the position of the radiation spot. Preferably, the predetermined threshold value is set to 90 to 99% of the near field control signal in the absence of a disc (or with the disc further away than a near field distance in the order of a few 100 nm).

In decision step 506, if the value of the near field control signal is found to be below the predetermined threshold value, it is decided that optical exit face 301 of the solid immersion lens (SIL) 206 need to be cleaned. If it was decided that cleaning is needed, the optical exit face 301 of the solid immersion lens (SIL) 206 is cleaned according to a suitable method known in the art in step 508 (CLN). For example, a suitable method for cleaning the optical exit face of solid immersion lens (SIL) 206 has been described by the applicant in European Patent application no 05106634.8 (Attorney docket no PH001858). If the optical exit face 301 of the solid immersion lens (SIL) 206 is found clean, the method proceeds to step 507 (USE) wherein the optical scanning apparatus is used.

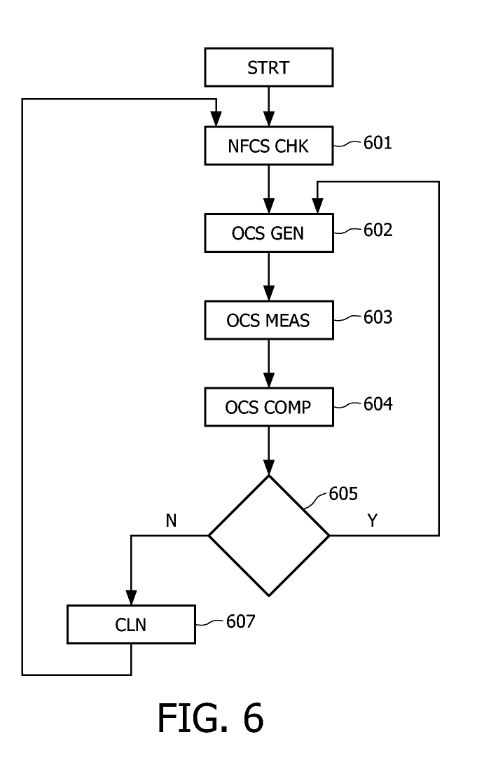

FIG. 6 illustrates a second embodiment of a method of checking the cleanness status of an optical exit face of a refractive element according to the invention; Further reference will be made to the optical scanning apparatus of the near field type as described with reference to FIG. 1 and the optical pick-up unit as described with reference to FIG. 2.

The method according to the second embodiment starts with a step 601 of checking the cleanness status based on using the near field control signal (NFCS CHK). Consequently, step 601 comprises the sequence of steps from 501 to 506 from the method according to the first embodiment. Should the lens be found clean in step 602, the method proceeds to step 602. Herein the optical disc 103 is brought to a readout distance with respect to the optical exit face of the solid immersion lens 206 and the optical head is aligned with respect to a track of the optical disc. While information is read from or recorded onto the optical disc 103, in an optical scanning apparatus several optical control signal are generated, for example a tracking error signal, a focusing error signal, a central error signal (also referred as a push pull signal) or a sum bead signal (SBAD). Such optical control signal is generated in step 602 (OCS GEN), measured in step 603 (OCS MEAS) and compared to an optical control signal threshold value in step 604 (OCS COMP). If the value is found above said threshold value, in step 605 it is decided that the optical exit face of the solid immersion lens 206 is not clean and the method proceed to step 607 when cleaning according to a suitable method (CLN). The monitoring of the optical control signal is performed continuingly while the optical disc 103 is scanned.

By monitoring a quality indicator of the playback signal such as the jitter level, the signal modulation or peak-to-peak amplitude of the data signal, it is possible to detect a deterioration of the spot quality. For example, in case contamination/dirt of the optical exit face of the solid immersion lens, the transmission of said SIL lens and/or the spot quality will be affected, leading to a reduced or distorted signal modulation. Disadvantage of monitoring optical control signal related to the data signal, such as the jitter level, is that reliable data needs to be present on the optical disc, which may not be the case during recording or on empty tracks. Therefore, it is preferred in an advantageous embodiment to monitor on optical control signal used for tracking, e.g. the push-pull signal instead of optical control signal related to the data signal.

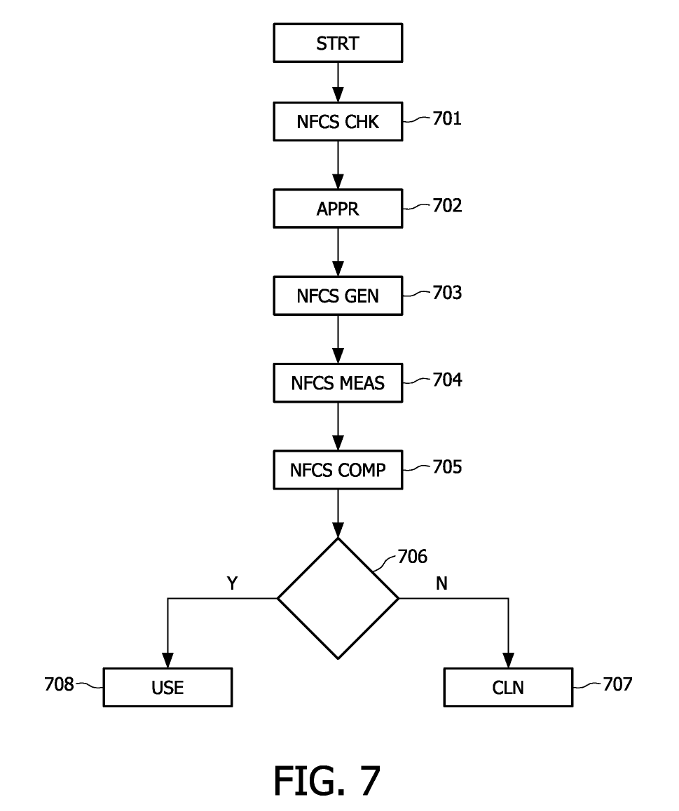

FIG. 7 illustrates a third embodiment of a method of checking the cleanness status of an optical exit face of a refractive element according to the invention; further reference will be made to the optical scanning apparatus of the near field type as described with reference to FIG. 1 and the optical pick-up unit as described with reference to FIG. 2.

The method according to the third embodiment starts with a step 701 of checking the cleanness status based on using the near field control signal(NFCS CHK). Consequently, step 701 comprises the sequence of steps from 501 to 506 from the method according to the first embodiment. In step 702 the optical disc 103 is approached gently by the solid immersion lens 206 until the optical exit face 301 of the solid immersion lens 206 is in contact with the surface of the optical disc 103 (APPR). For example, a suitable method of approaching for an optical scanning apparatus of the near field type was described by the applicants in Application no. 112005/052485 (Attorney Docket no PHNL040913), to be inserted herein by reference).

In step 703, the near field control signal is generated (NFCS GEN), in step 704 the generated near field control signal is measured (NCS MEAS) and in step 705 the near field control signal is compared to a second threshold value (NFCS COMP). If the near field control signal is found to be above a threshold value, it is decided in step 706 that the optical exit face is contaminated/dirty and the method proceeds to a performing a cleaning step 707 according to a suitable method known in the art (CLN). If the optical exit face of the solid immersion lens 206, the method may optionally include the step of checking the quality of an optical control signal, as described in the method according to the second embodiment.

If pull-in is attempted on static (non-rotating) optical disc 103, the value of the near field control signal during contact indicates the height of possible contamination/dirt the optical exit face of the solid immersion lens 206. In the clean situation, the value of the near field control signal during contact is typically less than 20%, and preferably less than 10% of the value of the near field control signal when the optical disc 103 is outside a near field distance. Larger values indicate the presence of contamination on the optical exit face of the solid immersion lens 206. Preferably, the near field control signal is the Gap Error Signal (GES).

For improved results, the second and third embodiment of the method can be combined. In such a combined method, the pre-check at start-up comprises checking the value of the near field control signal against the first threshold value before bringing the optical exit face of the solid immersion lens 206 into contact with the optical disc 103, followed by checking the value of the near field control signal against the second threshold value during contact. While the optical disc 103 is scanned, the quality of an optical control signal, preferably the tracking signal, is monitored continuously.

It should be noted that the above-mentioned embodiments are meant to illustrate rather than limit the invention. And that those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The invention may be implemented by means of hardware comprising several distinct elements and/or by means of a suitable firmware. In a system/device/apparatus claim enumerating several means, several of these means may be embodied by one and the same item of hardware or software. The mere fact that certain measures are recited in mutually different dependent claims does not indicate that a combination of these measures cannot be used to advantage.

1. A method of checking the cleanness status of an optical exit face of a refractive element of an optical scanning apparatus of the near field type, the method comprising step of
generating a near field control signal proportional to ratio between the intensity of an optical radiation beam that is internally reflected from the optical exit face of the refractive element and the intensity of a corresponding incident optical radiation beam;
measuring the near field control signal when the optical exit face of the refractive element is further away from an optical disc than a near field distance;
comparing the measured near field control signal with a predetermined threshold value;
deciding the refractive element is clean if the measured near field control signal is above the predetermined threshold value.

2. A method according to claim 1, characterized by the near field control signal being a Gap Error Signal (GES), the Gap Error Signal (GES) being proportional to the intensity of a reflected optical radiation beam having a polarization state perpendicular to the polarization state of the incident optical radiation beam.

3. A method according to claim 2, characterized by the predetermined threshold value being within a range of 90% to 99% of the value of the Gap Error Signal (GES) measured when then optical exit face of the refractive element is clean and the optical disc is outside a near field distance from the refractive element.

4. A method according to claim 2, characterized by the method further comprising a step of bringing the refractive element out of focus, preceding the step of measuring the near field control signal.

5. A method according to claims 4, characterized by the step of bringing the refractive element out of focus comprising moving a collimator lens of an optical pick-up unit.

6. A method according to claim 1, the method further comprising steps of
bringing the optical disc at a readout distance from the optical exit face of the refractive element;
generating an optical control signal;
monitoring the value of the optical control signal;
deciding that the optical exit surface of the refractive element is not clean if the measured optical control signal exceeds an optical signal threshold value.

7. A method according to claim 6, characterized by the optical control signal being a push-pull signal.

8. A method according to claim 1, the method further comprising steps of
bringing the optical disc in contact with the optical exit face of the refractive element;
measuring the near field control signal;
comparing the measured near field control signal with a second threshold value;
deciding that the optical exit surface of the refractive element is clean if the measured near field control signal is below a second threshold value.

9. A method according to claim 8, characterized by the second threshold value being in a range of 0% to 10% of the value of the near field control signal measured when the optical exit surface of the refractive element is clean and the optical disc is outside a near field distance from the refractive element.

10. A method according to claim 1, characterized by the near field distance being one tenth of the wavelength of the optical radiation beam.

11. A near field optical scanning apparatus for scanning an optical disc, the apparatus comprising
a front-end unit for generating a forward optical radiation beam and detecting a reflected optical radiation beam and for generating a near field control signal;
an optical head assembly, the optical head assembly comprising a refractive element for transmitting the forward optical radiation beam towards the optical disc and transmitting the reflected optical radiation beam from the optical disc towards the front-end unit;
a threshold unit for receiving the near field control signal from the front-end unit and comparing the near field control signal against a threshold value;
a control unit for controlling the threshold unit and the front-end unit; wherein
the near field control signal proportional to ratio between the intensity of an optical radiation beam that is internally reflected from the optical exit face of the refractive element and the intensity of a corresponding incident optical radiation beam;
the threshold unit is enabled to compare the measured near field control signal with a predetermined threshold value and the control unit is enabled to decide that the optical exit face of the refractive element is clean if the measured near field control signal is above the predetermined threshold value.

12. A near field optical scanning apparatus according to claim 11, wherein the near field control signal generated by the front-end unit is a Gap Error Signal (GES), the Gap Error Signal (GES) being proportional to the intensity of the reflected optical radiation beam having a polarization state perpendicular to the polarization state of the incident optical radiation beam.

13. A near field optical scanning apparatus according to claim 12, wherein the predetermined threshold value is chosen within a range of 90% to 99% of the value of the Gap Error Signal (GES) measured when then refractive element is clean and the optical disc is outside a near field distance from the refractive element.

14. A near field optical scanning apparatus according to claim 11, wherein the optical head assembly (105) is further enabled to bring the refractive element out of focus.

15. A near field optical scanning apparatus according to claims 14, wherein the optical head assembly is enabled to bring the refractive element out of focus by moving a collimator lens.

16. A near field optical scanning apparatus according to claim 11, wherein
the optical head assembly is further enabled to bring the refractive element at a readout distance from the optical disc;
the front-end unit is further enabled to generate an optical control signal;
the control unit is further enabled to monitor the value of the optical control signal and to decide that the optical exit surface of the refractive element is not clean if the measured optical control signal exceeds an optical signal threshold value.

17. A near field optical scanning apparatus according to claim 16, wherein the optical control signal is a push-pull signal.

18. A near field optical scanning apparatus according to claim 11, wherein
the optical head assembly is further enabled to bring the optical exit face of the refractive element in contact with the optical disc;
the threshold unit is further enabled to compare the near field control signal against a second threshold value;
the control unit is further enabled to decide that the optical exit surface of the refractive element is clean if the measured near field control signal is below a second threshold value.

19. A near field optical scanning apparatus according to claim 18, wherein the second threshold value is in a range of 0% to 20%, preferably below 10%, of the value of the near field control signal measured when then the optical exit surface of the refractive element is clean and the optical disc is outside a near field distance from the refractive element.

20. A near field optical scanning apparatus according to claim 11, wherein the near field distance is one tenth of the wavelength of the optical radiation beam.
